(19) United States
(12) Patent Application Publication
(10) Pub. No.: US 2008/0155504 A1
(43) Pub. Date: Jun. 26, 2008

(54) METHOD AND SYSTEM FOR AUTOMATED MERGING OF MULTIPLE VERSIONS OF A SOFTWARE COMPONENT FOR AN APPLICATION

(75) Inventor: Tom Thuan CHEUNG, San Jose, CA (US)

Correspondence Address: SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/614,832

(22) Filed: Dec. 21, 2006

(51) Int. Cl. G06F 9/44

(52) U.S. Cl. 717/120

(57) ABSTRACT

A method and system provides a merging process that provides an algorithm for processing the results of multiple versions of a software component or file such that further filtering of the changes can be automated to the extent that they reduce development time (and in some cases, errors). The method and system also provides efficient, simple and flexible process such that it can be modified and customized for different development processes.

### FIELD OF THE INVENTION

The present invention relates generally to software components and more particularly to a method and system for efficiently merging multiple versions of a software component for an application.

### BACKGROUND OF THE INVENTION

Software components or files of an application are updated on a regular basis. What is meant by a software component is any file that undergoes changes and/or different versions over time. Oftentimes it is desirable to remove code changes on a component. The code changes may or may not be the latest and so additional changes have been made to the source files of the software components. It is important to be able to remove/update changes made inbetween a multi-versioned development model. Currently, the process for making the changes is very individualized, manual, and dependent on the developer to manually evaluate and determine appropriate updates. There are file or code comparison tools such as Windiff published by Microsoft Corporation, which show the difference between two versions. However, these tools are not effective when more than two versions of code is involved.

Accordingly, what is needed is a system and method for addressing the above-identified issues. The present invention addresses such a need.

### SUMMARY OF THE INVENTION

A method and system provides a merging process that provides an algorithm for processing the results of multiple versions of a software component or file such that further filtering of the changes can be automated to the extent that they reduce development time (and in some cases, errors). The method and system also provides efficient, simple and flexible process such that it can be modified and customized for different development processes. The present invention allows for more automation and flexible logic. From current testing, there is a substantial savings in development time as developers will only need to focus on changes which do need manual evaluation.

### BRIEF DESCRIPTION OF THE DRAWINGS

FIG. 1 illustrates different versions of source file.

FIG. 2 shows utilizing the impact version to relate the other two versions.

FIG. 3 shows file inputs and output to the merging process engine.

FIG. 4 is a block diagram of a system in accordance with the present invention.

FIG. 5 illustrates parsing of the AI and CI input files.

FIG. 6 illustrates an impact array which comprises a plurality of elements with an impact cursor.

FIG. 7 illustrates the process by which parsing occurs for both the AI and CI input files.

FIG. 8 illustrates the evaluation phase of the merging process in accordance with an embodiment.

FIG. 9 shows the AC file in accordance with the present invention.

### DETAILED DESCRIPTION

The present invention relates generally to software components and more particularly to a method and system for efficiently merging multiple versions of a software component. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### Conceptual Definitions

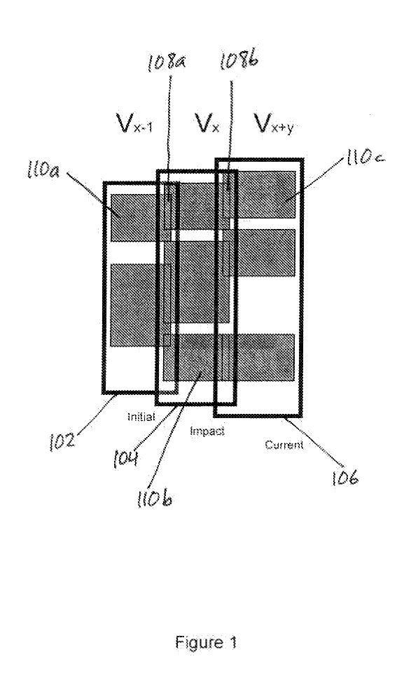

Within a controlled development environment, each change of code logic of a software component results in a new version of the source file (code). Over time, there will be linear versions stored centrally in a source repository such as IBM's CMVC (configuration management version control). Within a single linear version set, an automated merging system in accordance with the present invention can be used to remove a specific versioned change, specified as Vₓ. With removal, it is necessary to logically merge the immediate previous version (Vₓ₋₁) with a newer version (V_{x+y}). These different versions are shown in FIG. 1.

The Vₓ₋₁ version is referred as the initial version 102, Vₓ is referred as the impact version 104, and V_{x+y} is referred as the current version 106. The diagram shows that overlaying each of the versions together reveals sections which are common 108a-b and sections which are specific 110a-c to one or more of the versions.

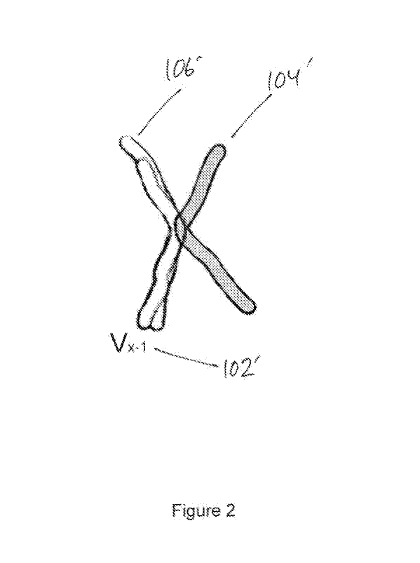

One of the fundamental differentiating concepts of the merging process in accordance with the present invention the processing of the three versions is accomplished. In a system and method in accordance with the present invention is that the impact version 104′ is utilized and compared with the other two versions (initial 102′ and current 106′) in the same manner, as depicted in FIG. 2.

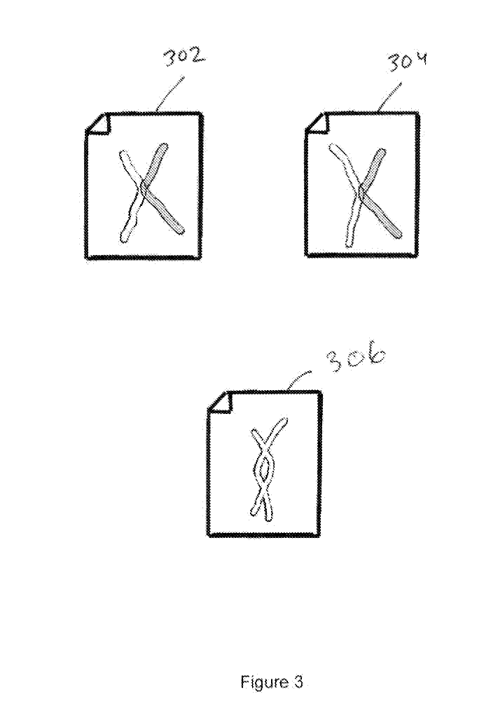

As shown, Vₓ(impact) version is related with both V_{x+y}(current) and Vₓ₋₁(initial) versions from the “right” perspective. “Right” here means from the programming logic perspective. Therefore, current and initial are from the “left” programming logic perspective. Furthermore, it is expected that the comparisons between initial (“left”) and impact (“right”) and between current (“left”) and impact (“right”) are passed in as file inputs to the merging process engine. These file inputs and the output are shown in FIG. 3.

The initial (“left”) and impact (“right”) comparison is referred as the AI file 302 and the current (“left”) and impact (“right”) comparison is referred as the CI file 304. Generation of the AI and CI files can be provided for example by existing comparison tools/programs such as windiff.exe and diff. The merging process in accordance with the present invention is able to process the AI/CI input files 302 and 304 to provide a merged output file (AC) 306.

The merging process in accordance with the present invention therefore provides for a formal systematic process for the removal of unwanted code logic(s) added in cycle within the typical versioned development model. To describe the features of the present invention in more detail refer now to the following discussion in conjunction with the accompanying figures.

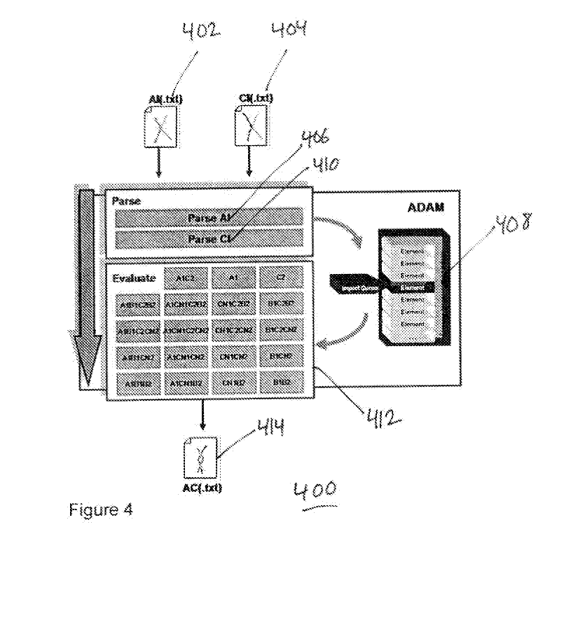

FIG. 4 is a block diagram of a system 400 in accordance with the present invention. The system provides for the following:

(1) Generating an AI(.txt) 402 and CI(.txt) 404 files;

(2) Parsing of the AI file 406 into an impact element array 408;

(3) Parsing of CI file 410 into the impact element array 408;

(4) Evaluating the impact element array 408 based upon the AI file and the CI file;

(a) For each element combination in the impact element array 408, executing a default action;

(b) Generating a AC(.txt) file 414; and

(5) Reviewing the AC(.txt) file 414 and providing an execution output.

The benefits of using such a system are as follows:

(a) Simplicity: the process is simple, and implementation does not require extensive programming skills.

(b) Flexibility: the identification and separation of the element combination allows for custom actions specific to the existing development model used.

(c) Portability: implementation in any programming language which supports file read/write, string, and array manipulation such as C, C++, Java.

(d) Reduction of development costs because code updates, which are numerous but immediately determinable, are automatically processed.

(e) Reduction in human errors because the process is systematical and is not dependent upon or affected by differences in developer skills and experiences.

To describe the merging process in more detail refer now to the following description in conjunction with the accompanying figures.

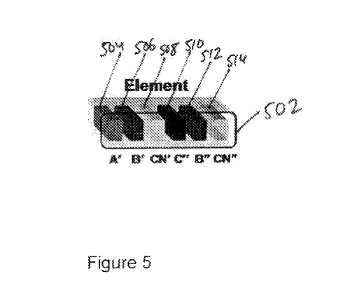

FIG. 5 illustrates the parsing of the AI and CI input files. As is seen the AI and CI input files are parsed in order to construct a specific element 502. The specific element 502 is the smallest unit for processing and comprises a combination of:

A′ 504 which represents the initial specific code segments identified in the AI file.

B′ 506 which represents the impact specific code segments identified in the AI file.

CN′ 508 which represents the common code segments identified in the AI file.

C″ 510 which represents the current specific code segments identified in the CI file.

B″ 512 which represents the impact specific code segments identified in the CI file.

CN″ 514 which represents the common code segments identified in the CI file.

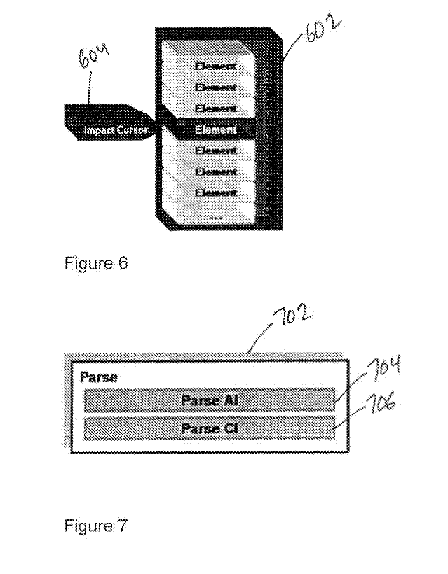

FIG. 6 illustrates an impact element array 602 which comprises a plurality of elements 603 with an impact cursor 604. The specific element is based on the impact version, and the complete collection of elements parsed is defined as the impact element array 602.

The impact cursor 604 represents the current processing element and signifies that the element is individually processed/parsed depending on the specific combination.

The process by which parsing occurs for both the AI and CI input files is illustrated in FIG. 7. It should be understood that the parsing of AI and CI can be performed in any order and that would be within the spirit and scope of the present invention.

Here the parse phase 702 consists of logic to parse AI 704 and parse CI 706. While depicted here as logically separate, it is not a requirement that the parsing be separate code-wise. Pseudocode of the parsing is as follows:

```
Vector ImpactElementArray;
Int ImpactCursor = 0;
public parse( )
{
  // local variables
  ...
  Element currentElement = new Element( );
  while (read line from input file not EOF)
  {
    if (line read is “LEFT”)
    {
      Append line to currentElement.LEFT;
    }
    else if (line read is “RIGHT”)
    {
      Add line to currentElement.RIGHT;
      Add currentElement to ImpactElementArray;
      currentElement = new Element( );
      ImpactCursor ++;
    }
    else // line read is “COMMON”
    {
      Add line to currentElement.COMMON;
      Add currentElement to ImpactElementArray;
      currentElement = new Element( );
      ImpactCursor ++;
    }
  }
  if (currentElement.LEFT != “”) // case when LEFT is at end
  {
    Add currentElement to ImpactElementArray;
    ImpactCursor ++;
  }
}
```

Note: If parsing the second file, the pseudocode will be slightly different because the element will be retrieved from the existing impact element array.

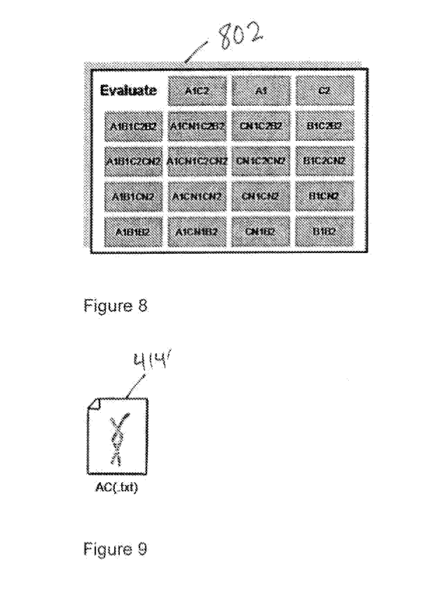

After parsing has completed, the impact element array is complete and ready to be evaluated, leading to the evaluation phase 802 of the merging process as shown in FIG. 8.

In one embodiment, each element combination is to be handled by a separate subroutine, allowing for custom logic to be easily added that reflects to specifics of the particular development process. Additionally, because of the unique parsing, there is only a finite combination cases (in this case, 19) to be handled which is smaller than the mathematical combination of 36 (3×2×1×3×2×1). It should be understood that although 19 combinations are shown in this embodiment it should be understood that any number of combinations are possible. The key factor is that the number of combinations will be less than the factorial combination of elements.

The 19 exemplary combinations are described below along with the default logic (action):

### Combination 1: A1 B1 C2 B2

Interpretation:

The element has been modified on all three versions (initial, impact, current).

This requires additional manual evaluation.

Logically, B1=B2.
Default Action: (Manual Evaluation)

Inform user to evaluate manually

Add//A1

Add//B2

Add//C2

### Combination 2: A1 B1 C2 CN2

Interpretation:

The element has been changed during impact version, C2 was added afterwards.

Because of parsing logic, C2 is appended to the element.

Logically, B1=CN2.
Default Action: (Keep Current Change, Undo Impact Change)

Add C2

Add A1
Combination 3: A1 B1 CN2
Interpretation:

The element has been changed during impact version.

Logically, B1=CN2.
Default Action: (Undo Impact Change)

Add A1

### Combination 4: A1 B1 B2

Interpretation:

The element has been changed during impact version. It has been removed during current version (after Impact version).

Logically, B1=B2.
Default Action: (Manual Evaluation)

Inform user to evaluate manually

Add//A1

Add//B2

### Combination 5: A1 CN1 C2 B2

Interpretation:

A1 was removed during impact version. Element was changed during current version (after\impact version).

Logically, CN1=B2.
Default Action: (Undo Impact Change, Keep Current Change)

Add A1

Add C2

### Combination 6: A1 CN1 C2 C2

Interpretation:

A1 was removed during impact version. C2 was adding during current version (after impact version).

Logically, CN1=CN2.
Default Action: (Manual Evaluation)

Inform user to evaluate manually

Add//A1

Add//C2

Add CN1
[001]

### Combination 7: A1 CN1 CN2

Interpretation:

A1 was removed during impact version.

Logically, CN1=CN2.
Default Action: (Undo Impact Change)

Add A1

Add CN2

### Combination 8: A1 CN1 B2

Interpretation:

A1 was removed during impact version. B2 was removed during current version (after impact version).

Logically, CN1=B2.

Default Action: (undo impact change, keep current change) Add A1

### Combination 9: CN1 C2 B2

Interpretation:

Element was updated during current version (after impact version).

Logically, CN1=B2.
Default Action: (Keep Current Change)

Add C2

### Combination 10: CN1 C2 CN2

Interpretation:

C2 was added during current version (after impact version). No change to element.

Logically, CN1=CN2.
Default Action: (Keep Current Change)

Add C2

Add CN2

### Combination 11: CN1 CN2

Interpretation:

No change.

Logically, CN1=CN2.
Default Action:

Add CN1

### Combination 12: CN1 B2

Interpretation:

Element was removed during current version (after impact version).

Logically, CN1=B2.
Default Action: (Keep Current Change)

do nothing

### Combination 13: B1 C2 B2

Interpretation:

B1 was added during impact version. It was updated during current version (after impact version).

Logically, B1=B2.
Default Action: (Manual Evaluation)

Inform user to evaluate manually

Add//B1

Add//C2

### Combination 14: B1 C2 CN2

Interpretation:

B1 was added during impact version. C2 was added during current version (after impact version).

C2 and B1 are separate.

Logically, B1=CN2.
Default Action: (Undo Impact Change, Keep Current Change)

Add C2

### Combination 15: B1 CN2

Interpretation:

B1 was added during impact version.

Logically, B1=CN2.
Default Action: (Undo Impact Change)

do nothing

### Combination 16: B1 B2

Interpretation:

B1 was added during impact version. It was removed during current version (after impact version).

Logically, B1=B2.
Default Action: (Undo Impact Change, Keep Current Change)

do nothing

### Combination 17: C2

Interpretation:

This occurs when element C2 is added during current version (after impact version) at the end.
Default Action: (Keep Current Change)

Add C2

### Combination 18: A1

Interpretation:

This occurs when element A1 was removed during impact version at the end.
Default Action: (Undo Impact Change)

Add A1

### Combination 19: A1 C2

Interpretation:

This occurs when element A1 was removed during impact version at the end and element C2 is added during current version (after impact version) at the end.
Default Action: (Manual Evaluation)

Inform user to evaluate manually

Add//A1

Add//C2

The result of the evaluate phase is the AC file which is a merging of the initial and current logic minus the impact logic. FIG. 9 shows the AC file 414′ in accordance with the present invention.

If the merging was clean and no manual evaluation actions noted, the AC file 114′ can be used as the next version of the source (V_{x+y+1}). Otherwise, the developer will need to review the AC files for manual evaluation markings and handle them appropriately. In either case, it is expected that measurable development time (cost) is saved by handling of the automatic cases by a system and method in accordance with the present invention.

### Conclusion

A method and system provides a merging process that provides an algorithm for processing the results of multiple versions of a software component or file such that further filtering of the changes can be automated to the extent that they reduce development time (and in some cases, errors). The method and system also provides efficient, simple and flexible process such that it can be modified and customized for different development processes.

Although the present invention has been described in accordance with the embodiments shown, one of ordinary skill in the art will readily recognize that there could be variations to the embodiments and those variations would be within the spirit and scope of the present invention. Accordingly, although the embodiment described relates to source files that change over time one of ordinary skill in the art readily recognizes that the present invention applies to any file or application that changes over time or has multiple versions. Accordingly, many modifications may be made by one of ordinary skill in the art without departing from the spirit and scope of the appended claims.

What is claimed is:

1. A method for merging multiple versions of a software component comprising:
providing an initial comparison file; the initial comparison file comprising a comparison of an initial version of the software component and an impact version of the software component;
providing an current comparison file; the current comparison file comprising a comparison of a current version of the software component and the impact version of the software component;
parsing of the initial comparison file utilizing an impact element array, the impact element array comprising a plurality of elements;
parsing of the current comparison file utilizing the impact element array;
providing a specific element based upon the parsing of the initial comparison file and the current comparison file; wherein the specific element includes initial specific code segments identified in the initial comparison file; impact specific code segments identified in the initial comparison file; common code segments identified in the initial comparison file; current specific code segments identified in the current comparison file; impact specific code segments identified in the current comparison file; common code segments identified in the current comparison file;
utilizing the specific element to provide a plurality of element combinations; and
evaluating the element combinations within a current impact element array; wherein the number of combinations are limited by the specific element.

2. The method of claim 1 wherein an input cursor is utilized on a current processing element and indicates that the element is being processed based upon a specific combination.

3. The method of claim 1 providing a merging of the initial and current comparison file based upon the evaluation of the element combination.

4. The method of claim 1 wherein each element combination is handled by a separate subroutine.

5. The method of claim 1 wherein the parsing of the initial comparison file and the parsing of the current comparison file are performed in one piece of code.

6. The method of claim 1 wherein manual evaluation of the element combinations is provided as needed.

7. A computer readable medium containing program instructions for merging multiple versions of a software component, the program instructions for:
providing an initial comparison file; the initial comparison file comprising a comparison of an initial version of the software component and an impact version of the software component;
providing an current comparison file; the current comparison file comprising a comparison of a current version of the software component and the impact version of the software component;
parsing of the initial comparison file utilizing an impact element array, the impact element array comprising a plurality of elements;
parsing of the current comparison file utilizing the impact element array;
providing a specific element based upon the parsing of the initial comparison file and the current comparison file; wherein the specific element includes initial specific code segments identified in the initial comparison file; impact specific code segments identified in the initial comparison file; common code segments identified in the initial comparison file; current specific code segments identified in the current comparison file; impact specific code segments identified in the current comparison file; common code segments identified in the current comparison file;
utilizing the specific element to provide a plurality of element combinations; and
evaluating the element combinations within a current impact element array; wherein the number of combinations are limited by the specific element.

8. The computer readable medium of claim 7 wherein an input cursor is utilized on a current processing element and indicates that the element is being processed based upon a specific combination.

9. The computer readable medium of claim 7 providing a merging of the initial and current comparison file based upon the evaluation of the element combination.

10. The computer readable medium of claim 7 wherein each element combination is handled by a separate subroutine.
